(19) United States
(12) Patent Application Publication
(10) Pub. No.: US 2021/0170556 A1
(43) Pub. Date: Jun. 10, 2021

(54) SCREW CLAMPING TOOL

(71) Applicant: MENG-YU LAI, Taichung City (TW)

(72) Inventor: MENG-YU LAI, Taichung City (TW)

(21) Appl. No.: 17/109,474

(22) Filed: Dec. 2, 2020

(30) Foreign Application Priority Data
Dec. 4, 2019 (TW) 108216190

(51) Int. Cl. B25B 23/10; B25B 13/06

(52) U.S. Cl. CPC B25B 23/108; B25B 13/08; B25B 13/065

(57) ABSTRACT

A screw clamping tool includes a main body and an elastic clamping member. The main body has a driving portion having a driving bore which rotates about a rotation center for driving a screw member. A plurality of contact faces are disposed on an inner side of the driving bore, and a positioning groove concavely is formed on the driving bore. The elastic clamping member is formed of a non-metal material and disposed in the positioning bore and protruding on an inner edge of the driving bore with respect to the contact faces. When the screw member is received in the driving bore, the elastic clamping member stably clamps the screw member.

### BACKGROUND OF THE INVENTION

### 1. Field of the Invention

The present invention relates to tools, and more particularly, to a screw clamping tool for stably clamping a screw.

### 2. Description of the Related Art

Common hand tools, such as a wrench or a sleeve, are applied for wrenching a screw member, so as to fasten or loosen the screw member. However, the driving portion of the wrench or sleeve is not provided with an engagement structure. As a result, the screw member is easily detached from the wrench or sleeve and falls on the ground or the workpiece, causing inconvenience of user.

Therefore, for improving the issue above, a tool using magnetism or metal engagement ring is developed in the market for preventing the screw member form accidentally detachment from the tool. A magnetic tool, which has a magnetic embedded into the tool body, uses magnetism to attract the screw member. However, the magnet is substantially fragile, unfavorable for firm engagement, only applicable to iron component, and not usable for non-iron screw members. Also, in a high-temperature environment, the magnetism of the magnet is easily affected. Alternatively, regarding the tool applying a metal engagement ring, the clamping force of the metal ring is not easily controlled, and a corresponding groove on the screw member is a must for proper positioning, failing to meet the convenience of usage.

### SUMMARY OF THE INVENTION

For improving the issues above, a screw clamping member is disclosed, which applies a structurally simple, efficiently assembled, and non-metal elastic clamping member for clamping the periphery of the screw member, thereby achieving a stable clamping effect.

For achieving the aforementioned objectives, screw clamping tool in accordance with an embodiment of the present invention is provided, comprising a main body and an elastic clamping member. The main body comprises a driving portion having a driving bore, which rotates about a rotation center for driving the screw member. The driving bore has a plurality of contact faces and a positioning groove concavely formed on the driving bore. The elastic clamping member is formed of a non-metal material and disposed in the positioning and protrudes from the inner edge of the driving bore corresponding with respect to the contact faces. Therefore, when the driving bore receives the screw member, the elastic clamping member stably clamps the screw member.

With such configuration, the present invention applies a non-metal elastic clamping member for elastically clamping the screw member, so as to be applicable to screw members formed of iron and non-iron material, improving the application scope of the present invention.

### BRIEF DESCRIPTION OF THE DRAWINGS

FIG. 1 is a perspective view of a first embodiment of the present invention, illustrating the main body being in a form of an anti-slip sleeve.

FIG. 2 is an exploded view of the first embodiment of the present invention.

FIG. 3 is a top view of the first embodiment, illustrating the main body receiving a screw member, with the elastic clamping member contacting two corners of the screw member.

FIG. 4 is a top view of a second embodiment of the present invention, illustrating the main body being a hexagonal sleeve, with the elastic clamping member contacting the periphery of the screw member.

FIG. 5 is a top view of a third embodiment of the present invention, illustrating the main body being an open end wrench, with the elastic clamping member contacting the periphery of the screw member.

FIG. 6 is a top view of a fourth embodiment of the present invention, illustrating the main body being a box wrench, with the elastic clamping member contacting the periphery of the screw member.

FIG. 7 is a top view of a fifth embodiment of the present invention, illustrating the main body being a ratchet wrench, with the elastic clamping member contacting the periphery of the screw member.

FIG. 8 is a perspective view of a sixth embodiment of the present invention, illustrating the main body being an anti-slip sleeve, with the elastic clamping member mounted around the whole periphery of the driving bore.

FIG. 9 is a cross-sectional view taken along line 9-9 of FIG. 8, illustrating the elastic clamping member contacting the periphery of the screw member.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

As used herein, when a component is described as “disposed on” or “placed on” another component, the component is allowed to be “directly” disposed or placed on the other component or “indirectly” disposed or placed on the other component through an “intermediate member”. On the other hand, when a component is described as “directly disposed on” or “directly placed on” another component, there is no intermediate elements.

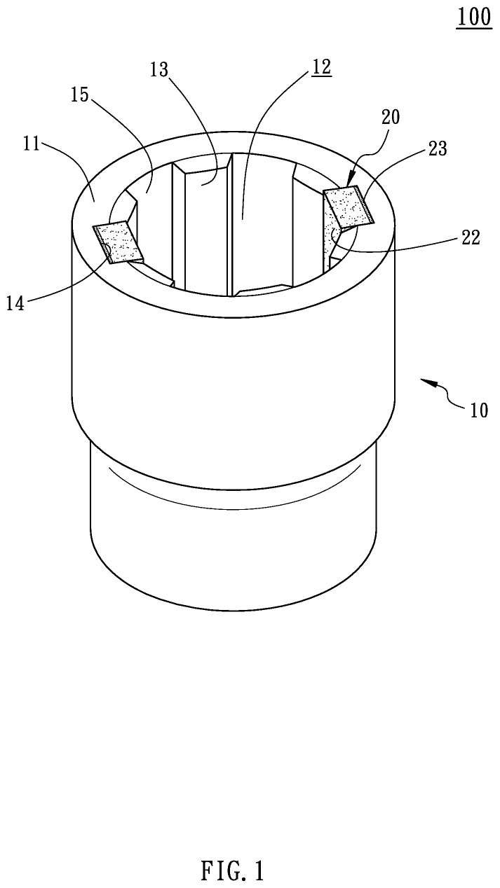

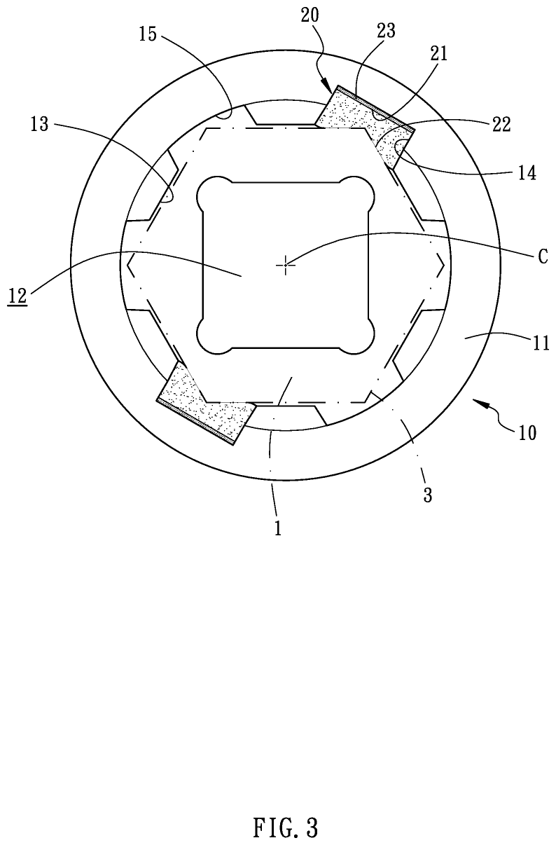

Referring to FIG. 1 and FIG. 3 illustrating the first embodiment of the present invention, a screw clamping tool 100 for stably clamping a screw is disclosed, comprising a main body 10 and an elastic clamping member 20. In the embodiment, the main body 10 is an anti-slip sleeve driven by a wrench for fastening or loosening a screw member 1.

The main body 10 comprises a driving portion 11 having a driving bore 12. The driving bore 12 is applied for receiving a screw member 1, so as to drive the screw member 1 to rotate about a rotation center C. A plurality of contact faces 13 are disposed on an inner side of the driving bore 12. A positioning groove 14 is concavely formed on the inner side of the driving bore 12. In an embodiment of the present invention, two positioning grooves 14 are provided and symmetrically spaced by the rotation center C. Therein, a spacing groove 15 is disposed between each two neighboring contact faces 13 for containing a corner 2 of the screw member 1, thereby avoiding corner collision during the screwing operation. Further, in an embodiment of the present invention, a positioning groove 14 is disposed between each two contact faces 13 on the same position wherein the spacing groove 15 is disposed. Also, the positioning groove 14 is disposed in a direction in parallel to the direction of the rotation center C.

The elastic clamping member 20 is formed of a non-metal material, such as chosen from a group consisting of rubber, natural leather, and artificial leather. Therein, the material, such as rubber and artificial leather can be formed by mix or separate foam forming. The elastic clamping member 20 is disposed in the positioning groove 14 and protrudes on the inner edge of the driving bore 12 with respect to the contact face 13. In an embodiment of the present invention, two elastic clamping member 20 are disposed on two corresponding sides of the driving bore 12. The elastic clamping member 20 comprises a fixing face 21 and an abutting face 22 in opposite to the fixing face 21. The fixing face 21 is adhered to the positioning groove 14 through an adhesive 23, so that the elastic clamping member 20 is fixed to the inner edge of the driving bore 12, and the abutting face 22 is applied for abutting against the periphery of the screw member 1.

Furthermore, the distance between the abutting face 22 and the contact face 13 is smaller than the distance between the fixing face 21 to the contact 13, such that the elastic clamping member 20 slightly protrudes on the inner edge of the driving bore 12 with respect to the contact face 13. In an embodiment of the present invention, the elastic clamping face 20 has a rectangular-shape sectional face. The abutting face 22 of the elastic clamping member 20 is colored. Different colors represent different size of the tool 100, facilitating the identification convenience for the user.

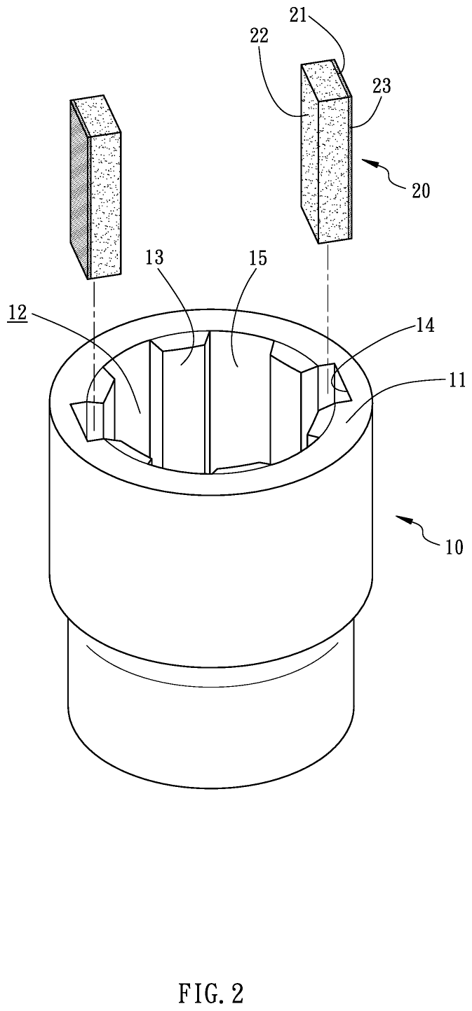

Referring to FIG. 2 and FIG. 3, when the tool 100 receives the screw member 1, two opposite corners 2 of the screw member 1 are disposed on the abutting face 22 of the elastic clamping member 20, and the contact face 13 of the driving bore 12 corresponds to the six peripheries 3 of the screw member 1. Therefore, when removing the wrench together with the tool 100 after loosening the screw member 1, the screw member 1 is still stably clamped by the main body 10 and the elastic clamping member 20, so as to be removed from the installation place as well, thereby preventing the screw member 1 form detaching from the main body 10 or falling on the ground or into the workpiece, achieving a stably clamping effect on the screw member 1.

Accordingly, the present invention improves the issue of conventional magnet or metal engagement ring, so as to be applicable to both iron and non-iron screw member 1. Also, the present invention is structurally simple, without the necessity of additionally processing an engagement recess or groove for cooperation with the elastic clamping member 20, thereby lowering the manufacturing cost.

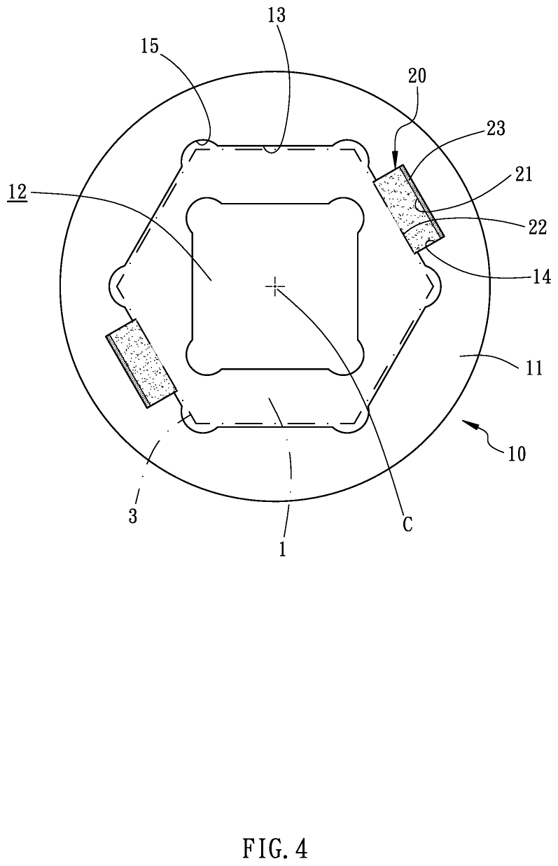

Referring to FIG. 4, the second embodiment of the present invention is illustrated. The same reference numbers in the second embodiment and the first embodiment represent identical components, structures, and function, so that relative descriptions are omitted. In the second embodiment, the main body 10 is a hexagonal sleeve having six inner corners. Therein, the driving bore 12 of the main body 10 has a shape identical to the shape of the screw member 1, and the positioning groove 14 is concavely formed on the contact face 13, so that when the screw member 1 is received in the driving bore 12, the elastic clamping member 20 abuts against the periphery 3 of the screw member 1.

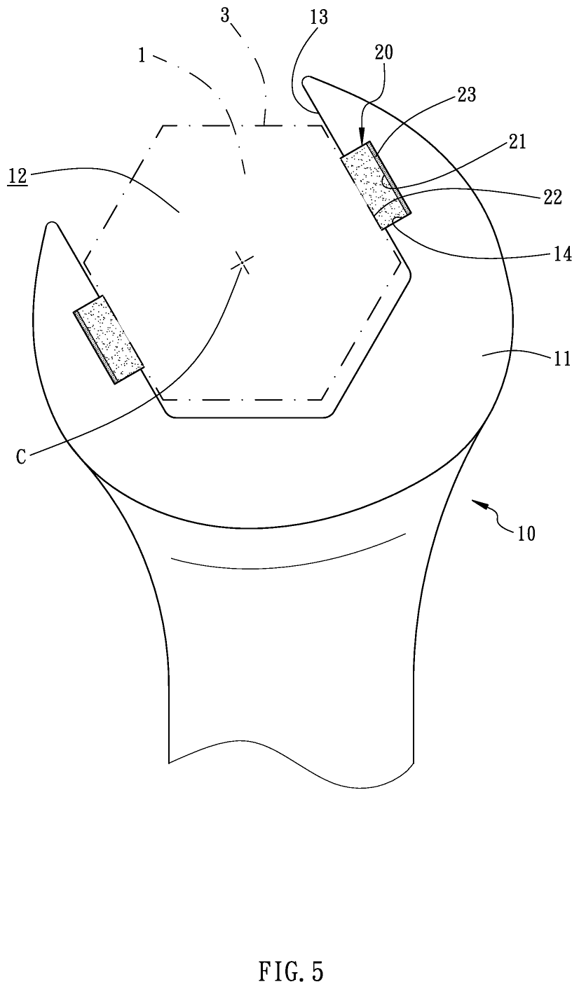

Referring to FIG. 5, the third embodiment of the present invention is illustrated. The same reference numbers in the third embodiment and the aforementioned embodiments represent identical components, structures, and function, so that relative descriptions are omitted. In the third embodiment, the main body 10 is an open end wrench, whose driving portion 11 includes two opposite jaws which form the driving bore 12 formed on the inner edge of the jaws. The driving bore 12 has the contact face 13, with the positioning groove 14 concavely formed on the contact face 13, so that when the screw member 1 is received by the driving bore 12, the elastic clamping member 20 abuts against the periphery 3 of the screw member 1.

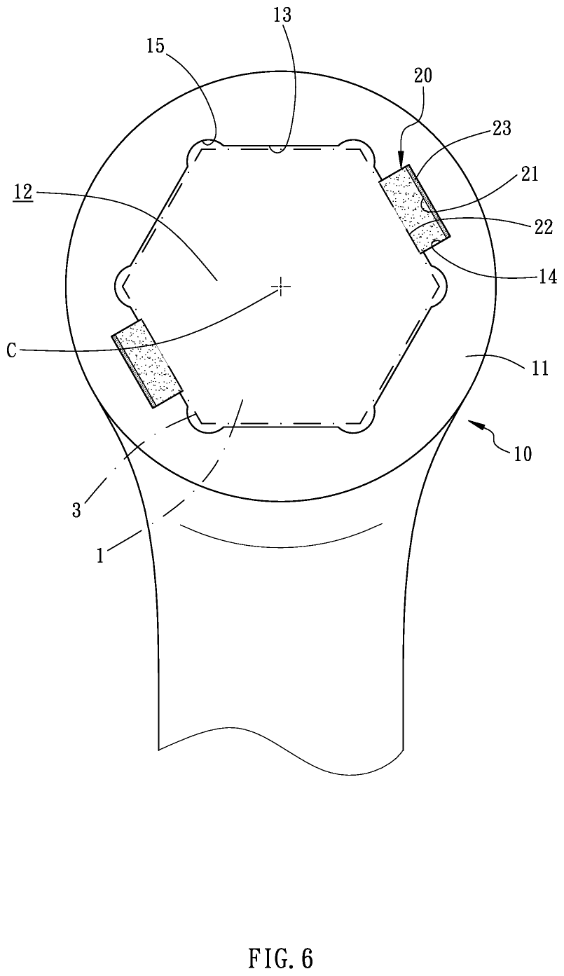

Referring to FIG. 6, the fourth embodiment of the present invention is illustrated. The same reference numbers in the fourth embodiment and the aforementioned embodiments represent identical components, structures, and function, so that relative descriptions are omitted. In the fourth embodiment, the main body 10 is a box wrench, with the positioning groove 14 also concavely formed on the contact face 13, so that when the screw member 1 is received in the driving bore 12, the elastic clamping member 20 abuts against the periphery 3 of the screw member 1.

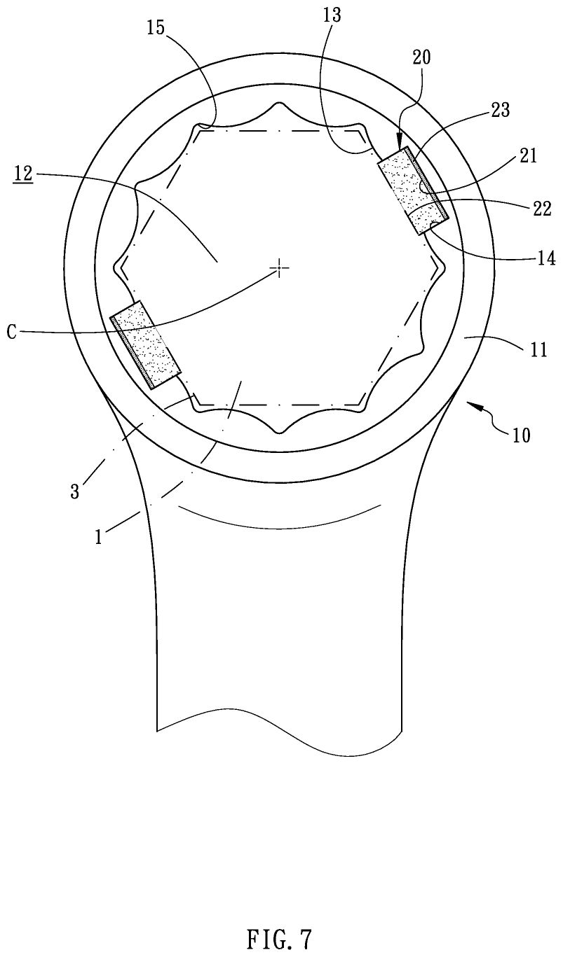

Referring to FIG. 7, the fifth embodiment of the present invention is illustrated. The same reference numbers in the fifth embodiment and the aforementioned embodiments represent identical components, structures, and function, so that relative descriptions are omitted. In the fifth embodiment, the main body 10 is a ratchet wrench, whose driving portion 11 is a ratchet ring, with the elastic clamping member 20 disposed on the inner edge of the ratchet ring, so that when the screw member 1 is received in the driving bore 12, the elastic clamping member 20 abuts against the periphery 3 of the screw member 1.

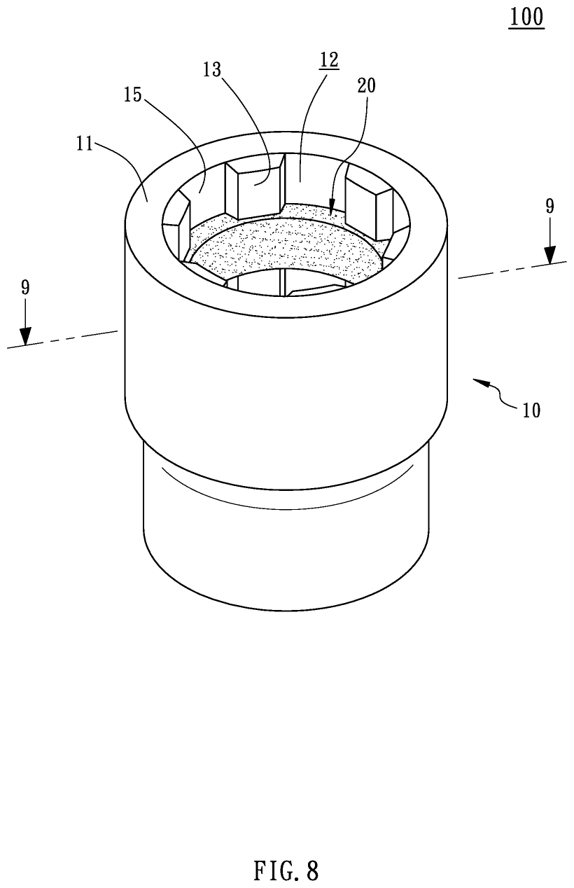

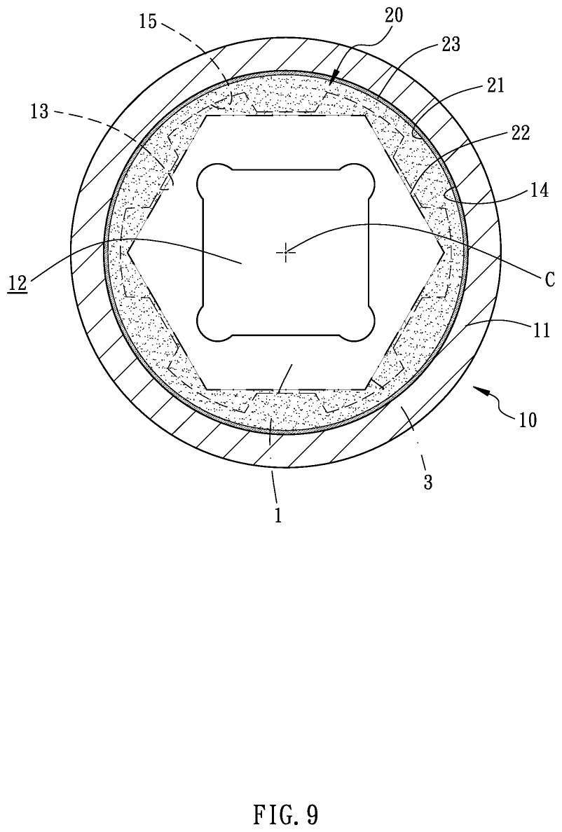

Referring to FIG. 8 and FIG. 9, the sixth embodiment of the present invention is illustrated. The same reference numbers in the sixth embodiment and the aforementioned embodiments represent identical components, structures, and function, so that relative descriptions are omitted. In the sixth embodiment, the main body 10 is an anti-slip sleeve, which has the positioning groove 14 disposed along a direction perpendicular to the rotation center C. In other words, the positioning groove 14 is radially disposed on the driving bore 12, such that the elastic clamping member 20 is mounted on the whole periphery of the driving bore 12. Therefore, when the screw member 1 is received in the driving bore 12, the elastic clamping member 20 abuts against the sixth peripheries 3 of the screw member 1, achieving the identical functions aforementioned.

With the foregoing configuration, the present invention achieves following technical effects.

The present invention has a non-metal elastic clamping member 20 disposed on the inner edge of the driving bore 12 of the main body 10. By stably clamping the screw member 1 with the elastic force of the clamping member 20, the screw member 1 is prevented from accidentally detaching from the main body 10 and causing inconvenience of operation.

The non-metal elastic clamping member 20 allows the present invention to be applicable to both iron and non-iron screw member 1, so as to enlarge the application scope.

The screw member 1 is stably clamped by the elastic clamping member 20 without the need of being provided with an engagement recess or groove. Therefore, the present invention is structurally simple, easily assembled, and effectively lowers the manufacture cost.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A screw clamping tool, comprising:
a main body having a driving portion, the driving portion having a driving bore which rotates about a rotation center for driving a screw member, a plurality of contact faces being disposed on an inner side of the driving bore, and a positioning groove concavely formed on the driving bore; and
an elastic clamping member formed of a non-metal material, the elastic clamping member being disposed in the positioning bore and protruding on an inner edge of the driving bore with respect to the contact faces, such that when the screw member is received in the driving bore, the elastic clamping member stably clamps the screw member.

2. The screw clamping tool of claim 1, wherein the elastic clamping member comprises a fixing face and an abutting face in opposite to the fixing face; the fixing face is adhered on the positioning groove with an adhesive, and the abutting face abuts against a periphery of the screw member.

3. The screw clamping tool of claim 2, wherein the positioning groove is disposed in a direction parallel to a direction of the rotation center; the positioning groove is disposed between two neighboring contact faces.

4. The screw clamping tool of claim 2, wherein the positioning groove is disposed in a direction parallel to a direction of the rotation center; two elastic clamping members and two positioning grooves are provided, and concavely disposed on the contact faces, respectively, and arranged on two corresponding sides of the driving bore.

5. The screw clamping tool of claim 2, wherein the positioning groove is disposed along a direction perpendicular to the direction of the rotation center.

6. The screw clamping tool of claim 3, wherein a distance between the abutting face and the contact face is smaller than a distance between the fixing face to the contact face.

7. The screw clamping tool of claim 7, wherein the elastic clamping member has a sectional face formed in a rectangular shape.

8. The screw clamping tool of claim 7, wherein the elastic clamping member is formed of a non-metal material selected from a group consisting of rubber, natural leather, and artificial leather.

9. The screw clamping tool of claim 4, wherein a distance between the abutting face and the contact face is smaller than a distance between the fixing face to the contact face.

10. The screw clamping tool of claim 9, wherein the elastic clamping member has a sectional face formed in a rectangular shape.

11. The screw clamping tool of claim 10, wherein the elastic clamping member is formed of a non-metal material selected from a group consisting of rubber, natural leather, and artificial leather; and the abutting face is colored.

12. The screw clamping tool of claim 5, wherein a distance between the abutting face and the contact face is smaller than a distance between the fixing face to the contact face.

13. The screw clamping tool of claim 12, wherein the elastic clamping member has a sectional face formed in a rectangular shape.

14. The screw clamping tool of claim 13, wherein the elastic clamping member is formed of a non-metal material selected from a group consisting of rubber, natural leather; and the abutting face is colored.
